(19) United States
(12) Patent Application Publication
(10) Pub. No.: US 2016/0064741 A1
(43) Pub. Date: Mar. 3, 2016

(54) ELECTRODE DESIGN WITH OPTIMAL IONOMER CONTENT FOR POLYMER ELECTROLYTE MEMBRANE FUEL CELL

(71) Applicant: GM Global Technology Operations LLC, Detroit, MI (US)

(72) Inventors: Swaminatha P. Kumaraguru, Rochester Hills, MI (US); Roland J. Koestner, Penfield, NY (US); Irina Kozhinova, Penfield, NY (US)

(21) Appl. No.: 14/474,743

(22) Filed: Sep. 2, 2014

(51) Int. Cl. H01M 4/86; H01M 8/10; H01M 4/92; H01M 4/88

(52) U.S. Cl. CPC H01M 4/8657; H01M 4/8825; H01M 8/1004; H01M 4/8663; H01M 4/92; H01M 4/8807; H01M 2300/0065

(57) ABSTRACT

A method of making a membrane electrode assembly for a fuel cell, a membrane electrode assembly, a fuel cell and a fuel cell system. The method includes preferentially adsorbing an ionomer and electrocatalyst mixture onto the surface of a porous fuel cell substrate by appropriate treatment of the mixture prior to or contemporaneous with placement of the mixture onto the substrate. This promotes retention of the ionomer-coated electrocatalyst at or near the surface of the substrate where catalytic activity between it and a proton exchange membrane is designed to take place. Retention of the ionomer-coated electrocatalyst near these interfacial regions by the present invention is preferable to having the ionomer and electrocatalyst be significantly absorbed into the substrate.

### BACKGROUND OF THE INVENTION

The present invention generally relates to a method and apparatus for forming an electrode for an ion-exchange membrane and more particularly to a way to optimize the placement of an ionomer for ion-exchange membrane used in a fuel cell.

Electrochemical fuel cells convert reactants in the form of fuel and oxidant into electricity. In a typical fuel cell system, hydrogen or a hydrogen-rich gas is supplied as fuel to the anode side of a fuel cell while oxygen (such as in the form of atmospheric oxygen) is supplied to the cell's cathode side. In one configuration, the anode and cathode (which together form an electric circuit when current flowing from the former to the latter is routed through a connected external load) are separated by a thin, flexible polymer electrolyte membrane (PEM) that prevents gas crossover and electric current flow but permits proton migration from the anode to the cathode. The combined cathode-PEM-anode assembly is referred to as the membrane electrode assembly (MEA), where the anode and cathode include a gas-permeable medium to facilitate respective hydrogen or oxygen transport, as well as an electrocatalyst layer placed in, on or otherwise adjacent to the gas-permeable medium for accelerating the electrochemical reduction and oxidation reactions. In one common form, the electrode layers are made from porous, electrically conductive sheet material, such as carbon fiber paper, carbon cloth or related gas diffusion media or gas diffusion substrate that, in addition to promoting the introduction of the reactants to the MEA, help establish an electrically-conductive external circuit though which the electricity generated at the electrodes may be routed. The electrocatalyst layer (also referred to herein as electrocatalyst, or more simply, catalyst) is typically in the form of rare-earth metal particles (for example, platinum) finely-dispersed onto a suitable substrate that forms an interface between (or is part of) the membrane and respective electrode.

In one process, MEAs are manufactured using a decal transfer process, also commonly referred to as the catalyst coated on membrane (CCM) process. In this process, the electrocatalyst is coated onto the PEM by first depositing it onto a decal substrate and then transferring the coated substrate to the PEM via hot press. This method is slow, involving numerous process steps and complexity that make it unsuitable for volume manufacturing. In addition, the CCM process can lead to film formation at the interface; such formation may lead to a performance loss. Moreover, selective or tailored ionomer distribution across or through the electrode thickness is not achievable via this process.

Another process for manufacturing an MEA is the catalyst coated on diffusion media (CCDM) process, wherein the catalyst ink—which is typically a mixture of electrocatalyst (typically Pt or Pt-alloy supported on carbon) and an ionomer (for example, a perfluorosulfonic acid) in an alcohol-water solvent system—is coated directly onto the porous gas diffusion media. In addition to promoting a desirably consistent amount of target substrate surface wetting, the CCDM process leads to less complexity than the CCM process during integration of the MEA, thereby providing significant benefits in volume manufacturing. Nevertheless, difficulties persist, as the absorption or drainage of ionomer into the thickness of the porous gas diffusion media substrate impacts its catalytic usefulness, especially how it can limit the electrocatalytic reaction to the region close to the ion-exchange membrane. In fact, in conventional CCDM processes, more than 50% of ionomer may be lost. Furthermore, using such an approach renders the overall MEA performance very sensitive to process conditions, where deposition speed, drying conditions or the like may result in additional optimization and validation steps every time the process changes.

### SUMMARY OF THE INVENTION

In accordance with the instant disclosure, and in view of the above and other disadvantages of the prior art, an electrode design with optimal ionomer content for a PEM fuel cell and a method of making such an electrode is shown through the use of a multi-step process where the catalytically active material is formed in such a way that it remains at or near the surface of the target ion-exchange membrane or diffusion media substrate as a way to ensure that the ionomer remains at its intended location during MEA formation. This significantly improves electrode design and CCDM process flexibility, as well as reduces ionomer waste. It also permits a more tailored way to provide ionomer coverage through a multilayered coating deposition (i.e., graded layer approach) where each layer may contain an ionomer content specific to that layer.

According to an aspect of the present invention, a method of making an MEA for a fuel cell includes combining an ionomer and electrocatalyst together with a first solvent and then removing the first solvent to create a dried ionomer-coated electrocatalyst. After the ionomer-coated electrocatalyst has been substantially dried, it is treated. This treatment promotes adsorption of the ionomer-coated electrocatalyst on a porous surface of a substrate (such as a diffusion media or the like) rather than being absorbed beneath the surface. In this way, upon subsequent placement of the ionomer-coated electrocatalyst onto such a substrate, the ionomer-coated electrocatalyst remains predominantly on top (rather than inside) the substrate. It will be appreciated by those skilled in the art that by being predominantly on the top does not require that it remain completely on (rather than in) the substrate, but merely that significant portions (such as the approximately 50% levels mentioned above in conjunction with the prior art) of the ionomer-coated electrocatalyst avoid penetrating beyond the immediate surface of such a substrate. After treatment of the ionomer-coated electrocatalyst, it is applied to a porous substrate such that together they are placed in contact with the opposing sides of a proton-conductive membrane to form an MEA. As mentioned above, this method promotes adsorption and retention of the ionomer-coated electrocatalyst near the interfacial regions of the MEA that are formed between the membrane and the respective porous substrates rather than have the ionomer and electrocatalyst be significantly absorbed into the substrate.

Significantly, treatment of the ionomer-coated electrocatalyst can be achieved by at least one liquid-based approach and at least a dry powder-based approach. For example, the so-called “wet” treatment may include placing the ionomer-coated electrocatalyst that has been separated from the initial solvent or ink into contact with a second solvent to create a second ink that can then be applied to the porous substrate. In such an approach, it is preferable that the ionomer-coated electrocatalyst is substantially insoluble in this second solvent. Likewise, the so-called “dry” treatment involves annealing the ionomer-coated electrocatalyst prior to applying it to the porous substrate. Although considered dry, this annealed ionomer-coated electrocatalyst may further be placed in a solution to prevent any further dissolution of ionomer prior to applying it to the porous substrate. A variation of the “dry” approach may include dispersing or otherwise applying the treated ionomer-coated electrocatalyst as a dry powder onto the surface of the porous substrate, after which an annealing step is used to promote substantial adhesion between the treated ionomer-coated electrocatalyst and the surface of said gas diffusion media.

According to another aspect of the present invention, a fuel cell and a fuel cell system made from one or more fuel cells includes the preferentially-adsorbed ionomer and electrocatalyst as part of each MEA. In one form, the system includes a fuel cell stack made up of numerous fuel cells, along with various flowpaths and ancillary pumping or pressurizing equipment to convey reactants and their byproducts to and from the stack, a controller, water-management equipment or the like.

### BRIEF DESCRIPTION OF THE SEVERAL VIEWS OF THE DRAWINGS

The following detailed description of the preferred embodiments of the present invention can be best understood when read in conjunction with the following drawings, where like structure is indicated with like reference numerals and in which:

FIG. 1 is an illustration of a partially exploded, sectional view of a portion of a simplified fuel cell MEA and surrounding bipolar plates;

FIG. 2 shows an electron probe micro analysis (EPMA) signal for sulfur at various depths though the thickness of an MEA that was produced according to the prior art;

FIG. 3 shows a flowchart depicting the various steps to optimizing ionomer content in an MEA according to an aspect of the present invention;

FIG. 4 shows a transmission electron microscopy (TEM) image of an ionomer coated on catalyst according to an aspect of the present invention;

FIG. 5 shows a normalized ionomer-to-carbon (I/C) ratio at two varying I/C ratio levels for both conventional CCDM electrode coatings and those of the present invention; and

FIG. 6 shows a performance comparison between an MEA prepared by conventional CCDM process and that of the present invention.

### DETAILED DESCRIPTION OF THE PREFERRED EMBODIMENTS

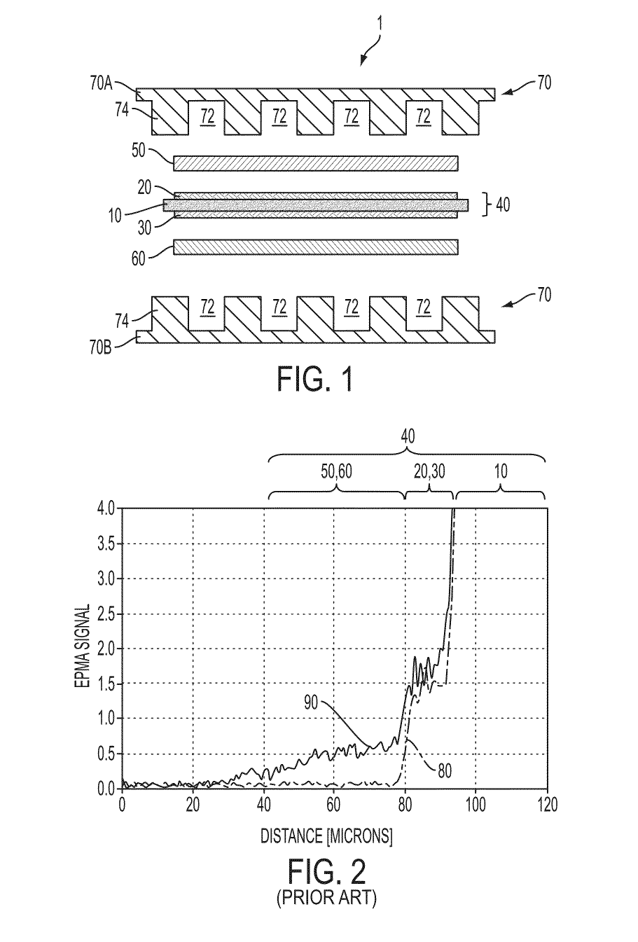

Referring initially to FIG. 1, a partial, sectional view of a conventional PEM fuel cell 1 in exploded form is shown. The fuel cell 1 includes a substantially planar proton exchange membrane 10 (which in one form may be made from a perfluorinated sulfonic acid (PFSA) ionomer (such as Nafion®)), anode catalyst layer 20 in contact with one face of the proton exchange membrane 10, and cathode catalyst layer 30 in contact with the other face. Collectively, the proton exchange membrane 10 and catalyst layers 20 and 30 make up the MEA 40. A pair of porous substrates in the form of an anode diffusion layer 50 and a cathode diffusion layer 60 are arranged to be in facing contact with the respective catalyst layers 20, 30. In the present context, the diffusion layers 50, 60 are typically made of carbon paper (or related) porous substrate to facilitate the passage of gaseous reactants to the catalyst layers 20 and 30; these substrates may in one form coated with a microporous layer (MPL) made up in one embodiment of a mixture of carbon and Teflon. Regardless of the precise nature of such structure, the terms gas diffusion media (GDM), diffusion media, diffusion layer, microporous layer or the like may be understood to be interchangeable functional equivalents configured for placement adjacent the proton exchange membrane 10, so long as they provide the necessary fluid communication between the delivered reactant and the respective anode catalyst layer 20 or cathode catalyst layer 30. Moreover, the specific discussion of MPL and GDM as structural complements or equivalents will be apparent from the context. Collectively, anode catalyst layer 20 and cathode catalyst layer 30 are referred to as electrodes, and can be formed as separate distinct layers as shown, or in the alternate, as embedded into or on diffusion layers 50 or 60 respectively, as well as embedded in or on opposite faces of the proton exchange membrane 10.

In addition to providing a substantially porous flowpath for reactant gases to reach the appropriate side of the proton exchange (also referred to herein as ion-exchange) membrane 10, the diffusion layers 50 and 60 provide electrical contact between the electrode catalyst layers 20, 30 and the bipolar plate 70 (through lands 74) that in turn acts as a current collector. Moreover, by its generally porous nature, the diffusion layers 50 and 60 also form a conduit for removal of product gases generated at the catalyst layers 20, 30. Furthermore, the cathode diffusion layer 60 generates significant quantities of water vapor in the cathode diffusion layer. Such feature is important for helping to keep the proton exchange membrane 10 hydrated. Water permeation in the diffusion layers can be adjusted through the introduction of small quantities of polytetrafluoroethylene (PTFE) or related material.

Simplified opposing surfaces 70A and 70B of a pair of bipolar plates 70 are provided to separate each MEA 40 and accompanying diffusion layers 50, 60 from adjacent MEAs and layers (neither of which are shown) in a stack. It will be appreciated by those skilled in the art that multiple fuel cells may be stacked together, and that multiple stacks can be further coupled to increase the fuel cell power output. One plate 70A engages the anode diffusion layer 50 while a second plate 70B engages the cathode diffusion layer 60. Each plate 70A and 70B (which upon assembly as a unitary whole would make up the bipolar plate 70) defines numerous reactant gas flow channels 72 along a respective plate face. Lands 74 separate adjacent sections of the reactant gas flow channels 72 by projecting toward and making direct contact with the respective diffusion layers 50, 60. In operation, a first gaseous reactant, such as hydrogen, is delivered to the anode 20 side of the MEA 40 through the channels 72 from plate 70A, while a second gaseous reactant, such as oxygen (typically in the form of air) is delivered to the cathode 30 side of the MEA 40 through the channels 72 from plate 70B. Catalytic reactions occur at the anode 20 and the cathode 30 respectively, producing protons that migrate through the proton exchange membrane 10 and electrons that result in an electric current that may be transmitted through the diffusion layers 50 and 60 and bipolar plate 70 by virtue of contact between the lands 74 and the layers 50 and 60.

Referring next to FIG. 2 in conjunction with FIG. 1, the results of EPMA signals for sulfur through the thickness of the MEA 40 that includes one of catalyst layers 20, 30 and one of the accompanying diffusion layers 50, 60 of both the CCM and CCDM of the prior art is shown, where the increasing thickness along the abscissa corresponds to the view along an increasing depth of a stack of the MPL, catalyst layer and proton exchange membrane. In particular, first signal 80 corresponds to an MEA processed by a conventional CCM method (using a 0.9 I/C) and the second signal 90 corresponds to an MEA processed by a conventional CCDM method (using a 2.0 I/C). Since both the MPL (PTFE) and electrode (PFSA) layers contain fluorinated polymers, the use of sulfur provides a signal that is unique to the PFSA polymer as a way to track the PFSA polymer permeation into the MPL layer. In addition, the EPMA method has high sensitivity to sulfur loading compared to alternative electron scattering methods such as transmission electron microscopy-electron energy loss spectroscopy (TEM-EELS) or secondary electron microscopy-energy dispersive spectroscopy (SEM-EDS). With regard to the desired I/C ratio, the majority of the electrode is made of carbon powder with finely dispersed platinum or platinum alloy. As such, the amount of ionomer used is typically specified as a ratio of the carbon. As is shown in the middle section of the figure (which corresponds to the respective diffusion layer 50 or 60 that are each roughly 40 to 80 microns in thickness), second signal 90 shows that significant quantities of the ionomer (as evidenced by the increased sulfur presence) have drained into the MPL of one of the diffusion layers 50 and 60 and away from the catalytically-active interfacial surface region formed by the catalyst layers 20, 30 and the proton exchange membrane 10. This drainage (or absorption) into the diffusion layers 50 and 60—by virtue of occupying interstitial regions within the layer—has a tendency to reduce the porosity of the substrate that makes up the diffusion layers 50 and 60; this problem may be exacerbated in low temperature conditions. As mentioned above, the first signal 80 of the conventional CCM method isn't as prone to the drift of the ionomer away from the catalytic interfacial regions between the catalyst layers 20, 30 and accompanying diffusion layers 50, 60 or between the catalyst layers 20, 30 and accompanying proton exchange membrane 10 as that of the CCDM-base second signal 90; however, its inability to be suitably scaled up for high-volume production detracts from its viability.

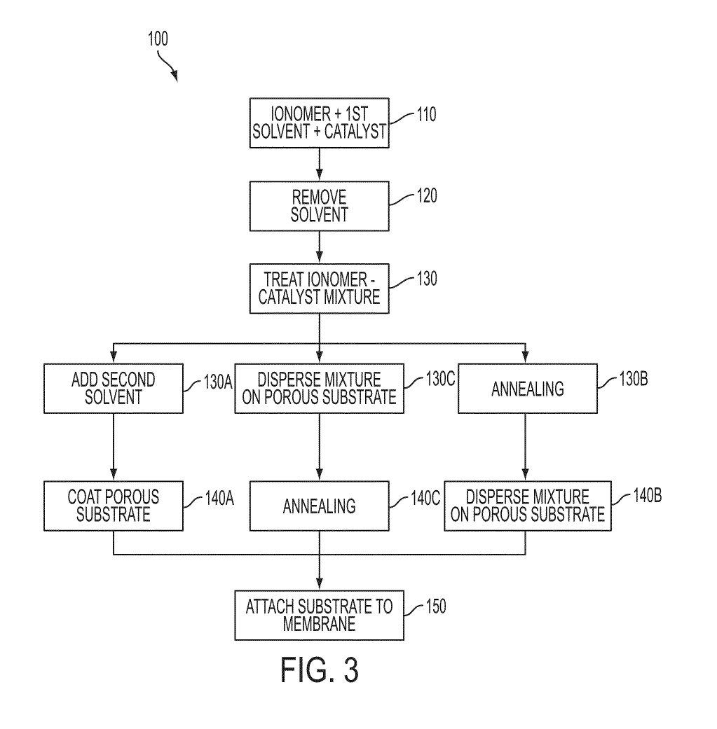

Referring next to FIG. 3, process steps according to a method 100 of producing an optimized ionomer loading in an MEA according to an embodiment of the present invention are shown. The first step 110 describes making a first ink with a discrete phase of catalyst and a continuous phase of ionomer solution in a water-alcohol solvent that easily wets the dry catalyst powder. The ionomer concentration is sufficiently low (typically 1-2% w/w solution) so that each chain is essentially non-overlapping during the freeze-quench process.

In the second step 120, the solvent in the first ink mixture is removed by a freeze-drying process (which is in effect a sublimation), whereby the individual ionomer chains collapse into ˜10 nm diameter spheroidal particles that decorate the dry catalyst surface. Within the present context, the freeze drying process generally takes place in three stages, including freezing, primary drying and secondary drying. Details of these stages of the second step 120 are discussed as follows.

Regarding the first stage of the second step 120, in one preferred approach, a freeze-drying apparatus (such as a Virtis Advantage Plus EL manufactured by SP Industries Inc.) is used on an electrode ink with a low ionomer concentration in solution (for example, approximately 0.90% perfluorosulfonated polymer by weight). In one form, the solvent composition for the freeze-dry process may use a water-rich solvent composition to provide a high aim freeze temperature; one example of such a solvent is BuOH:H₂O (in a 4:1 weight ratio), another is H₂O:ethanol:n-propanol:8:1:1.

In one form, the ink is formulated at 1.5% by weight carbon. For example, in situations where the solvent used in the electrode ink is the aforementioned BuOH:H₂O, the ink can be pre-frozen at minus 40° C., which is well below the eutectic (minus 5° C.) for the solvent; this in turn means that ice forms readily in the present process, while the peflourosulfonated polymer collapses into compact colloidal spheres due to the poor solvent quality at lower temperature.

More particularly, the ink to be frozen is placed in the first stage within the apparatus and cooled to minus 40° C. at ambient pressure (i.e., about 760 torr) for 2 hours, causing the ink to reach minus 10° C. within the first 20 minutes. A freeze chamber within the apparatus is then evacuated (for example, down to about 200 millitorr) with a temperature setpoint of about minus 15° C. to sublimate the polymer over an extended length of time (for example, 8 hours or more), thereby leaving a freeze-dried powder of catalyst decorated with colloidal polymer particles.

Regarding the second stage of the second step 120, indicia for the primary sublimation drying (evaporative cooling) can be in the form of a difference in the product versus a shelf temperature profile. The rate of sublimation of the hardened solvent (i.e., ice) depends upon the difference in vapor pressure of the pre-frozen material compared to the vapor pressure of the ice collector (i.e., cold trap). The solvent vapor migrates from the region of higher pressure to the region of lower pressure. Because the vapor pressure is related to the temperature, the material temperature needs to be warmer than that of the cold trap (which for the apparatus mentioned above may be in the range of minus 85° C.). This helps ensure that the temperature at which the material is freeze-dried is balanced between the temperature that maintains the frozen integrity of the product and the temperature that maximizes the vapor pressure of the product. The primary freeze-drying of this second stage completes as the material temperature approaches the shelf temperature, as evaporative cooling of the ink stops.

Regarding the third stage of the second step 120, after the primary drying of the second stage, the ink powder appears dry; however, the residual solvent content may still be significant (in one form, as high as 7-8%). This secondary drying of the third stage alleviates this, and is preferably conducted at warmer temperatures. Thus, after the shelf temperature set-point is established in the second stage, it may be increased to 25° C. for the secondary drying for an additional length of time (such as about 4 hours) to remove any residual or adsorbed solvent. Thereafter, the chamber is then filled at ambient pressure to allow the freeze-dry catalyst-ionomer powder to be removed for storage. This process is called isothermal desorption in that any bound residual water is desorbed from the ink powder. Because the process is desorptive, the vacuum should be as low as possible (no elevated pressure) and the collector temperature as cold as can be attained. Such secondary drying is usually carried out for approximately ⅓ to ½ the time required for primary drying.

In a third step 130, this ionomer-coated electrocatalyst (also referred to herein as an ionomer/catalyst mixture, composite or the like) is treated 130 in one of various ways. In a first way 130A, the treatment includes placing the ionomer-coated catalyst in a second solvent to create a second catalyst ink, where in one particular embodiment, the solvent of this second catalyst ink is based on a butyl acetate (nBuOAc) solvent-system, although other non-aqueous solvents with a narrow range of 5-15 (and preferably 5-10) in dielectric constant. This narrow range in dielectric constant (discussed in more detail below) avoids re-dissolution of the ionomer particles but still supports electrostatic stabilization of the catalyst particles in the ink dispersion. In particular, the present inventors have determined that electrostatic stabilization of the discrete phase (i.e., the catalyst-ionomer particles) for the second electrode ink in a nBuOAc-nPrOH solvent has the following attributes. First, a solvent with low dielectric constant (i.e., 5 or lower) cannot solvate ionic charge in solution. As a result, free ion pairs (cation-anion) condense into an uncharged associated complex in low dielectric constant solvent since the energy required to separate the charge is too high without proper solvation of the charged ions. For example, the dissociation of

NaCl(solid)->Na⁺(solution)+Cl⁻(solution)

is pushed to the left as only solid NaCl solid is stable in a low dielectric constant solvent. Second, in order to coat the catalyst or catalyst-ionomer particle ink onto a suitable gas diffusion media (such as diffusion layers 50 and 60), these particles should be reasonably stable in a colloidal suspension, lest they form large agglomerates that are not conducive to uniform dry thickness coating and low surface roughness. Third, the electrostatic charge typically present on the catalyst or catalyst-ionomer particle surface provides colloidal stability to avoid such agglomeration in the coating ink. As such, if the solvent dielectric constant is too low (i.e, below about 5), the charge on the catalyst or catalyst-ionomer particle surface is sufficiently reduced; this in turn can lead to degradation in the electrode coating quality. Lastly, the progressive charge condensation for the ionomer can be followed by swell measurements for increasing nBuOAc fraction in the binary nBuOAc:nPrOH solvent system; these losses in solvent swell occur as the driving force for solvent to permeate the ionomer solid arise from the osmotic pressure associated with hydrogen cation—sulfonate anion pair. This driving force is removed as the ions condense to a free acid (uncharged) state in low dielectric solvents.

Treatment such as this leaves the ionomer-coated catalyst intact during subsequent application onto the porous substrate of diffusion layers 50 and 60. After this, the second catalyst ink mixture can be coated onto the porous substrate 140A, where the relative immiscibility of the ionomer/catalyst mixture in the liquid solvent helps to keep the mixture at or near the surface, even in situations where the fluid penetrates beneath the surface of the porous substrate. In a second way 130B, the treated freeze-dried ionomer-covered catalyst powder may be annealed to physically cross-link the ionomer chains on the catalyst surface.

In a particular embodiment, this annealing may take place at temperatures between 120° C. to 220° C. for varying lengths of time. After this, the annealed ionomer/catalyst mixture can be placed 140B (such as through powder-based dispersal or the like) such that it coats the porous substrate of diffusion layers 50 and 60. In a third way 130C, the treated freeze-dried ionomer covered catalyst powder may be first dispersed or otherwise placed onto the porous substrate and then annealed 140C; this has the effect of curing the powder in an adhesive way to the surface of the diffusion layers 50 and 60. After this, another step 150 involves attaching the porous substrate of diffusion layers 50 and 60 that now has the ionomer/catalyst mixture that is suitably limited in depth to the catalytic region of the adjacent surfaces between the substrates and an adjoining proton exchange membrane 10.

Thus, process steps mentioned above and shown in FIG. 3 with the suffix “A” call for dispersing the ionomer/catalyst mixture in a hydrophobic solvent such as nBuOAc, while those marked by suffix “B”—instead of using nBuOAc—subject the catalyst/ionomer mixture to one or more annealing steps 130B; this latter approach reduces the dissolution of the ionomer in standard solvent systems such as water, water/ethanol or water/propanol solvent systems, thereby allowing the ionomer's PFSA backbone to align into crystalline domains that do not melt until 230° C. (under dry conditions). Since these crystalline domains comprise largely the hydrophobic backbone of the PFSA polymer, they are also not easily dissolved again in the normally hydrophilic alcohol/water solvent. The annealing 130B also improves the ionomer dispersion on the surface of the respective catalyst layer 20, 30. As such, the annealing 130B serves two purposes: (1) better contact area between electrocatalyst and ionomer and (2) making the ionomer insoluble in a water/alcohol solvent so that the ionomer-electrocatalyst particles maintain a colloidal character in the second solvent system.

After the annealing 130B, the annealed ionomer/catalyst mixture is dispersed in a standard/conventional water-alcohol solvent system for placement on the porous anode diffusion layer 50 or cathode diffusion layer 60 substrates; such a feature is valuable for the present wet coating approach. Furthermore, while manufacturability may be enhanced by including the annealing 130B along with a simpler second solvent system such as the alcohol/water system, it is also possible to eschew the annealing 130B by choosing a more hydrophobic solvent such as n-butylacetate/n-propanol.

For a third process sequence shown in FIG. 3 with the suffix “C”, the second ionomer/catalyst ink is dispersed and coated as in suffix “A”, but an anneal step is added to physically cross-link the ionomer in the electrode layer after the final solvent drying process. This then locks the ionomer location in place during fuel cell operation.

The solvent composition for the second ink is limited to a narrow dielectric constant range. Table 1 shows the calculated dielectric constant for nBuOAc:nPrOH solvent mixtures. The resulting electrode layer shows poor cohesion with a pure nBuOAc solvent due to limited swell of the ionomer binder at this lower limit in dielectric constant. On the other hand, ionomer loss into the underlying porous gas diffusion media is observed at nBuOAc:nPrOH::7:3 w/w solvent, which represents the upper limit in solvent dielectric constant. As a result, the catalyst/ionomer particle ink is typically coated with 10-20% nPrOH in nBuOAc to achieve a calculated dielectric constant in the solvent mixture between 5 and 10.

TABLE 1

| EtOH | H₂O | nPrOH | nBuOAc | calc |
|---|---|---|---|---|
| (w/w) | (w/w) | (w/w) | (w/w) | dielectric |
| 0 | 1 | 0 | 0 | 78.54 |
| 0 | 0 | 1 | 0 | 20.10 |
| 0 | 0 | 0 | 1 | 5.00 |
| 0 | 0 | 1 | 9 | 6.66 |
| 0 | 0 | 2 | 8 | 8.29 |
| 0 | 0 | 3 | 7 | 9.88 |

By the present approach, the high-volume production attributes of a CCDM-based method are preserved, while avoiding the penetration problems associated with conventional ink formation and placement, most notably as it relates to little or no loss of ionomer into the porous gas diffusion layers 50 and 60. As such, the process of the present invention translates into saving most (if not all) of the 50% of the ionomer/catalyst mixture that would otherwise gravitate away from the catalytically active interfacial region within the MEA 40 when used in electrode coatings of a conventional CCDM process. In one form, the upper-bound thickness of the ionomer and electrocatalyst mixture that occupies the region between the membrane 10 and the gas diffusion layers 50 and 60 is about 20 microns; if the thickness is much greater, increased proton and gas transport resistances are incurred. In addition to cost advantages from a reduction in the loss of ionomer and a more precise, repeatable ionomer profile being formed along the thickness of the electrode, the process of the present invention eliminates the need for re-optimization in situations where different coating methods, speeds, drying profiles or the like are employed. Furthermore, this more precise ionomer profile allows the formation of composite coatings using numerous layers of ionomer coated catalyst, each tailored to different ionomer content needs. A composite coating may include numerous such layers in order to define a varied (for example, graded) ionomer profile through the thickness of anode or cathode diffusion layers 50, 60 that are used along with the proton exchange membrane 10 to make up the MEA 40. The present approach is further beneficial in that it promotes ease in manufacturing, as the ionomer coated catalyst can be stored for longer durations without aggregate formation, thereby facilitating on-demand use. Significantly, with a colloidal-type ionomer-catalyst, the I/C profile in the electrode layer can be tailored. For example, it would be preferred to have higher I/C at the membrane interface to support better proton transport, while a lower I/C would be preferred at the diffusion media interface to support better gas transport. In one form, a gradient of 10%-50% is desired depending on catalyst type and electrode thickness.

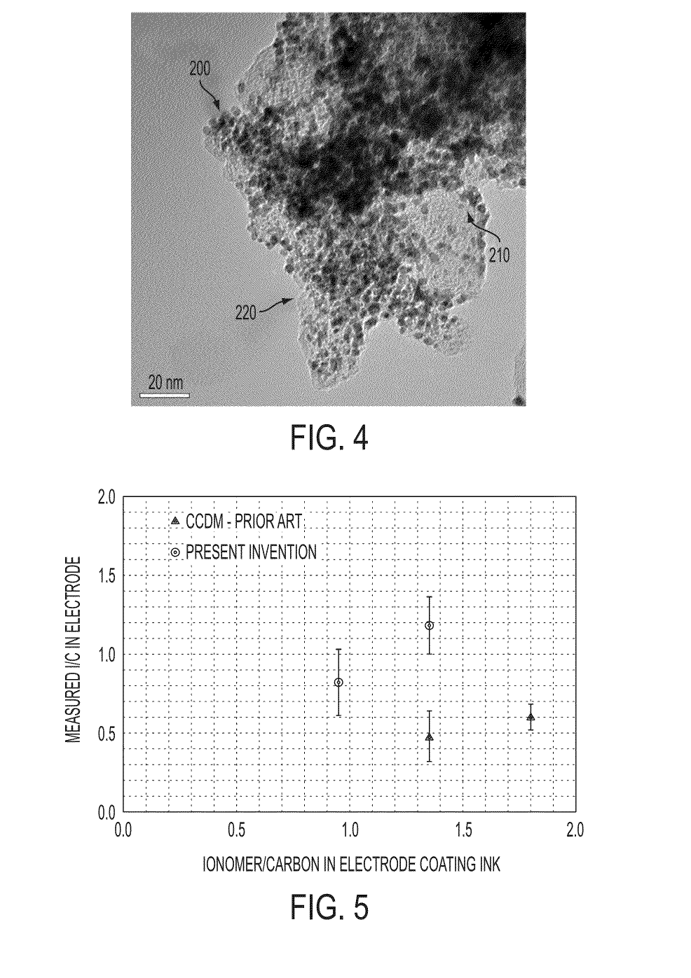

FIG. 4 shows the TEM image of ionomer coated catalyst prepared by the process of the present invention. The TEM images shows substantially uniform platinum particles 200 distributed on carbon support 210 with a thin uniform ionomer 220 coated on the surface of particles 200.

FIG. 5 represents a normalized I/C ratio for relative weight-to-weight (w/w) loadings of two ink components measured in the electrocatalyst layer for both a conventional CCDM electrode and an electrode made according to an aspect of the present invention versus the I/C ratio used in the electrocatalyst ink to prepare the electrode coatings. Energy dispersive x-ray analysis (EDX) was used as a qualitative tool to assess the approximate amount of ionomer in the electrocatalyst layer. For the conventional CCDM process, the I/C ratio from the ink does not translate into a corresponding I/C ratio measured in the electrocatalyst layer, indicating loss of remaining ionomer via absorption into the porous gas diffusion media. In the data presented in the figure, only about 40% of the ionomer from the input ink ends up in the catalyst layer in the conventional approach. Contrarily, for electrodes prepared via the presently-disclosed process, nearly 90% of the I/C ratio employed in the ink is retained in the electrocatalyst layer. This leads to increased utilization of ionomers as well as reproducible process to manufacture electrode coatings.

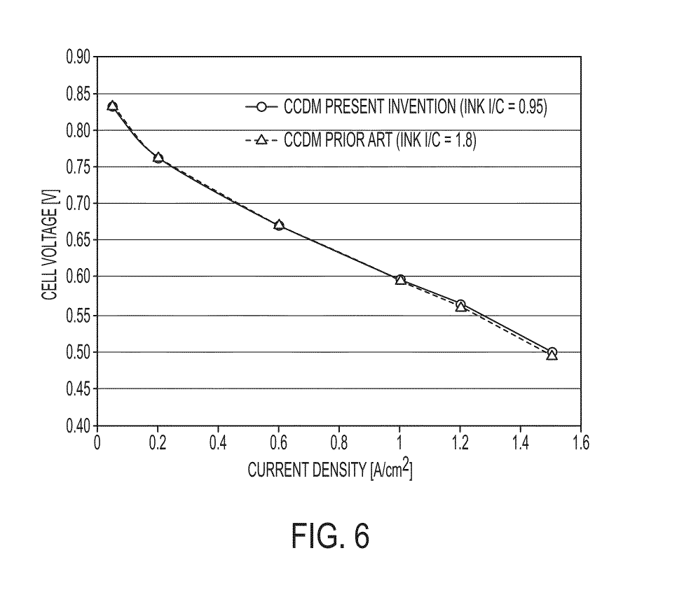

FIG. 6 shows the polarization curve of MEAs with 0.4 mg Pt/cm² cathode electrode. The control ink for catalyst coated diffusion media electrode prepared by conventional method (labeled as “CCDM—prior art”) uses over 1.8 I/C ratio (w/w). For the inventive process described in the present disclosure, the I/C ratio is less than 0.95. As shown, no difference in performance is observed between the MEAs made with the conventional process and the process of the present invention. Thus, the approach of the present invention uses less ionomer in the electrode. More importantly, it leads to a robust reproducible process with the several advantages mentioned above. In the present figure, the cathode performance is equivalent for the electrode even though a much lower I/C is added to the initial ink; this is assigned to a reduced permeation of the PFSA polymer from the applied electrode ink into the MPL layer as shown in the EPMA plot of FIG. 2.

While certain representative embodiments and details have been shown for purposes of illustrating the invention, it will be apparent to those skilled in the art that various changes may be made without departing from the scope of the invention, which is defined in the appended claims.

What is claimed is:

1. A method of making a membrane electrode assembly for a fuel cell, said method comprising:
combining an ionomer and an electrocatalyst together with a first solvent to create a first catalyst ink and then removing said first solvent from said first catalyst ink to create a dried ionomer-coated electrocatalyst;
treating said ionomer-coated electrocatalyst such that upon subsequent placement thereof onto a porous substrate, said ionomer-coated electrocatalyst is preferentially adsorbed thereon rather than absorbed therein;
applying at least one layer of said treated ionomer-coated electrocatalyst to said porous substrate; and
placing said porous substrate with said treated ionomer-coated electrocatalyst onto opposing sides of a proton-conductive membrane such that said membrane electrode assembly is defined thereby.

2. The method of claim 1, wherein said ionomer comprises perfluorosulfonic acid.

3. The method of claim 1, wherein said electrocatalyst comprises platinum or a platinum alloy.

4. The method of claim 1, wherein said first solvent comprises a combination of water and alcohol.

5. The method of claim 1, wherein said removing said first solvent is by freeze-drying.

6. The method of claim 1, wherein said porous substrate comprises a gas diffusion media.

7. The method of claim 6, wherein said treating comprises placing said ionomer-coated electrocatalyst in a second solvent to create a second catalyst ink.

8. The method of claim 7, wherein said ionomer-coated electrocatalyst is substantially insoluble in said second solvent.

9. The method of claim 8, wherein said second solvent comprises butyl acetate.

10. The method of claim 8, wherein said second solvent possesses a dielectric constant of between about 5 and about 15 such that said ionomer-coated electrocatalyst therein avoids re-dissolution while still supporting electrostatic stabilization.

11. The method of claim 7, further comprising removing at least a portion of said second solvent from said second catalyst ink.

12. The method of claim 6, wherein said treating comprises annealing said ionomer-coated electrocatalyst prior to applying it to said porous substrate.

13. The method of claim 12, wherein said annealing takes place at a temperature between 120° C. and 220° C.

14. The method of claim 12, further comprising placing said annealed ionomer-coated electrocatalyst in a solution to prevent any further dissolution of ionomer prior to applying it to said porous substrate.

15. The method of claim 14, wherein said solution is comprises at least one of water and butyl acetate.

16. The method of claim 6, wherein said applying said treated ionomer-coated electrocatalyst to said porous substrate comprises:
dispersing said ionomer-coated electrocatalyst as a dry powder onto a surface of said gas diffusion media; and
annealing said dispersed dry powder such that it substantially adheres to said surface of said gas diffusion media.

17. The method of claim 1, wherein said applying at least one layer of said treated ionomer-coated electrocatalyst to said porous substrate comprises applying a plurality of said layers to define a varied ionomer profile through the thickness of a respective anode diffusion media and cathode diffusion media that make up said membrane electrode assembly.

18. The method of claim 17, wherein said plurality of layers of ionomer comprise the same ionomer in varying degrees of ionomer content in at least two of said plurality of layers.

19. The method of claim 17, wherein said plurality of layers of ionomer comprise differing ionomer contents in at least two of said plurality of layers.

20. The method of claim 1, wherein a substantial entirety of said treated ionomer-coated electrocatalyst that is situated between said porous substrate and said proton-conductive membrane of said membrane electrode assembly remains substantially on an interfacial region formed between them.

21. The method of claim 20, wherein a thickness of said an interfacial region is no more than about 20 microns.
